(19) United States
(12) Patent Application Publication
(10) Pub. No.: US 2012/0099453 A1
(43) Pub. Date: Apr. 26, 2012

(54) Uplink Link Adaption at the User Equipment

(75) Inventors: Mats Sågfors, Kyrkslatt (FI); Stefan Parkvall, Stockholm (SE); Henning Wiemann, Aachen (DE); Janne Peisa, Espoo (FI); Stefan Wager, Espoo (FI)

(73) Assignee: TELEFONAKTIEBOLAGET LM ERICSSON (PUBL), Stockholm (SE)

(21) Appl. No.: 13/262,563

(22) PCT Filed: May 7, 2009
(86) PCT No.: PCT/SE09/50499

§ 371 Date: Sep. 30, 2011

Related U.S. Application Data
(60) Provisional application No. 61/166,407, filed on Apr. 3, 2009.

(51) Int. Cl. H04W 72/04; H04W 24/00; H04L 12/26

(52) U.S. Cl. 370/252; 370/329

(57) ABSTRACT

Method and arrangement in a user equipment for link adaptation of signals sent from the user equipment to a base station. The base station and the user equipment are comprised within a wireless communication system. The method comprises receiving information from the base station, comprising an indication of resource blocks available for transmission of signals from the user equipment to the base station, obtaining at least one of a user equipment related parameter or a link related parameter, and selecting a subset of the indicated available resource blocks received from the base station, based on at least one of the measured user equipment related parameter or the measured link related parameter, to be used for sending signals to the base station. Also, a method and arrangement in a base station for assisting a user equipment in performing link adaptation of signals is presented.

### TECHNICAL FIELD

The present invention relates to a method and arrangement in a user equipment and a method and arrangement in a base station. More in particular the present invention relates to a mechanism for link adaptation of signals sent from the user equipment to a base station.

### BACKGROUND

Link adaptation in wireless access is the mechanism for adjusting e.g. the coding, power, or modulation schemes to the currently prevailing link conditions. Typically, the mechanism includes some solution for measuring or estimating the current link characteristics, and based on that input, there is typically some selection or decision mechanism that decides e.g. the transmission power, channel coding, modulation scheme and/or antenna configuration that is considered most suitable when performing a transmission over the fading channel. This link adaptation allows for adapting the data transmission over a wireless link to very diverse fading conditions, where very high bit-rates can be supported in favourable conditions, and low, but sustainable, bit-rates are supported under challenging radio conditions.

The resource allocation is typically also affected by the transmission needs, i.e. the buffer fill level in the transmitter.

In the 3rd Generation Partnership Project (3GPP), work is ongoing on specifications of the UMTS Terrestrial Radio Access Network (UTRAN) evolution (E-UTRA) as part of the Long Term Evolution (LTE) effort.

Both UTRAN and LTE include support for such link adaptation, as briefly described below.

To support the link adaptation of the High-Speed Downlink Shared Channel (HS-DSCH) introduced in the Release 5 version of the 3GPP UTRAN specifications, the User Equipment (UE) can be configured to measure the downlink channel quality. The radio downlink is the transmission path from a base station to a user equipment, or a terminal as the user equipment also may be referred to as. The uplink is the inverse of a downlink, i.e. the transmission path from the user equipment to the base station. The user equipment then reports the measured results to the radio base station, e.g. a Node B, that may use these Channel Quality Indicator (CQI) reports in selecting appropriate resources, such as e.g. power and/or number of codes and Modulation and Channel coding (MCS) when transmitting to the user equipment. The choice of resources and modulation and channel coding will affect the number of information bits that is transmitted to the user equipment. The choice may also affect the number of HARQ re-transmissions that are required in order for the user equipment to successfully receive the transmitted transport block.

The Enhanced Dedicated Channel (E-DCH) introduced in Release 6 of the 3GPP UTRAN specifications supports user equipment selection of transport formats, where, given the scheduling constraints assigned by the by the scheduler in the network, the user equipment selects the number of information bits it sends based on buffer status and user equipment power budget. Each transport format is associated with a configurable power offset relative to the Dedicated Physical Control Channel (DPCCH), where DPCCH is controlled by fast power control. Thus, a user equipment close to the base station, i.e. with favourable link conditions will have a much better power budget compared to a user equipment far from the base station. Conversely, a user equipment close to the base station can send more information bits compared to a user equipment far from the base station, with the same amount of user equipment power.

E-DCH also supports Hybrid Automatic Repeat request (HARQ) with soft combining, and recently the support for higher order modulation has been introduced.

HARQ is a variation of the ARQ error-control method. In standard ARQ, error-detection information bits are added to data to be transmitted, such as Cyclic Redundancy Check, CRC. In standard ARQ, a block received in error is discarded and a retransmission is requested. In HARQ, received information is kept even if a block is in error, and this information is then combined with a re-transmission. As a result, HARQ performs better than ordinary ARQ in poor signal conditions.

Due to the non-orthogonality of the UTRAN channels, the described link-adaptation mechanisms above are important both to minimize the effects of intra- and inter-cell interference. Taking the uplink as an example, a user equipment should ideally only utilize the resources such as e.g. most suitable transport block size, power, etc. needed for successful decoding in the receiver with the least possible impact i.e. interference on other ongoing transmissions.

In the Long Term Evolution (LTE) of the UTRAN, e-UTRAN, the link adaptation is fully controlled by the radio base station, eNodeB, both in the downlink and uplink. Scheduling is modelled in the Medium Access Control (MAC) layer and resides in the eNodeB. The scheduler assigns radio resources, also called resource blocks, for the downlink (assignments) as well as for the uplink (grants) using the Physical Downlink Control Channel (PDCCH).

The characteristics of the downlink link adaptation in e-UTRAN are very similar to the UTRAN HS-DSCH solution: The user equipment can be configured to measure and report their link quality, based on reference symbols sent by the eNodeB. Based on these reports, the eNodeB selects the most appropriate resource and modulation and channel coding to be used when transmitting to the user equipment.

However, the uplink link adaptation in LTE is fundamentally different from the UTRAN E-DCH solution. In LTE, the user equipment has no freedom to select resource or modulation and channel coding, but it has to obey the selection performed by the eNodeB. The eNodeB signals this selection to the user equipment on the PDCCH control channel. One important reason for adopting this approach is that, in contrast to UTRAN, the intra-cell uplink resources are orthogonal. This means that each uplink time- and frequency transmission resource is allocated to a sole transmitter, and a transmission on this resource shall, ideally not interfere or be interfered by any other transmission associated with this cell. However, inter-cell interference may still be an issue, in case user equipment/transmitters in different cells, e.g. controlled by different eNodeBs are allocated the same resource blocks.

This approach, where the eNodeB decides and signals the selection, has many advantages, some important ones being less control information in the uplink and no blind detection in the receiver. There is no need to signal any information of the transport formats in the uplink, since the eNodeB uniquely knows what format to expect from the user equipment. Experiences from UTRAN have shown that the uplink control channels are expensive, resource wise. This is particularly true at cell edges, where the relative amount of power needed for successful transmission of any uplink control information increases.

Further, the eNodeB has full control of the shared resources and does not have to rely on multiple hypotheses when receiving transmissions from the user equipment, since the user equipment are not allowed to take any autonomous actions on the Physical Uplink Shared Channel (PUSCH).

The previous approach for LTE uplink scheduling, with a shared uplink channel fully controlled by the eNodeB, has some detrimental drawbacks.

The base station needs very accurate information for its uplink scheduling. In order for the eNodeB to select the best resource and modulation and channel coding, the eNodeB needs very accurate and timely information of the current uplink link conditions, power budget in the terminal, and user equipment buffer status. Such information can be offered to the eNodeB. However, the information does not come without costs. With uplink Sounding, it is possible for the eNodeB to measure the uplink link quality. However, Sounding creates additional interference in the system and consumes user equipment power.

With Power Headroom Report (PHR) and Buffer Status Report (BSR) from the user equipment to the eNodeB, it is possible to report the available power and buffer statuses, respectively, to the eNodeB.

However, timely updating of this information in the eNodeB require very frequent signalling of such reports that create undesired signalling overhead and consumes both radio resources and user equipment power. The Power Headroom and Buffer Status Reports are sent in-band, which further means that they are delayed by HARQ retransmissions, in case such retransmissions occur. Such re-transmissions may therefore delay the reception of information in the eNodeB about the current resource and transmission needs of the user equipment. In addition, it may be noted that the accuracy of both the Power Headroom Report and the Buffer Status Report is limited due to the quantization constrained by the number of bits used in the reports.

Altogether, it may be observed that missing, inaccurate and delayed information in the eNodeB regarding e.g. the uplink link quality, power headroom and/or user equipment buffer status may prevent the eNodeB from selecting the best resource and modulation and channel coding for uplink transmission. The resulting drawbacks of inaccurate transport format selection may have e.g. the following undesired effects:
Extra re-transmissions and/or packet losses, in case the user equipment did not have sufficient power to ensure successful reception of the commanded transport format in the eNodeB, given the current link conditions and user equipment power budget.
Under-utilization of resources, in case the transport format selection was unnecessarily “conservative”, and more information bits could have been transmitted with the available user equipment power budget and buffer status. As a consequence, the eNodeB may have to allocate additional resources in subsequent sub-frames to fulfil the transmission needs of the user equipment, leading to increased user equipment power consumption, inter-cell interference, and increased transmission delays.
Transmission of padding bits, at times e.g. when the eNodeB offers a transport format that is larger than the transmission needs of the user equipment. This results in unnecessary inter-cell interference and some loss of user equipment power that was invested on transmitting padding bits without any information value.
Delayed transmission, at times when the user equipment is not allowed to transmit all available information bits due to a too “small” scheduling assignment, or delayed scheduling assignment due to the aforementioned delays associated with the transmission of the Buffer Status Report.
Explicit signalling of e.g. buffer information is costly in terms of resource usage, which leads to lower capacity and/or coverage.

### SUMMARY

It is the object to obviate at least some of the above disadvantages and provide an improved performance within a wireless communication system.

According to a first aspect, the object is achieved by a method in a user equipment for link adaptation of signals sent from the user equipment to a base station. The base station and the user equipment are comprised within a wireless communication system. The method comprises receiving information from the base station. The received information comprises an indication of resource blocks available for transmission of signals from the user equipment to the base station. Also, the method comprises obtaining at least one of a user equipment related parameter or a link related parameter. Further, the method comprises selecting a subset of the indicated available resource blocks received from the base station. The selection is based on at least one of the measured user equipment related parameter or the measured link related parameter, to be used for sending signals to the base station.

According to a second aspect, the object is also achieved by an arrangement in user equipment for link adaptation of signals sent from the user equipment to a base station. The base station and the user equipment are comprised within a wireless communication system. The arrangement comprises a receiver. The receiver is adapted to receive information from the base station. The received information comprises an indication of resource blocks available for transmission of signals from the user equipment to the base station. Also, the arrangement comprises an obtaining unit. The obtaining unit is adapted to obtain at least one of a user equipment related parameter or a link related parameter. Further yet, the arrangement comprises a selecting unit. The selecting unit is adapted to select a subset of the indicated available resource blocks received from the base station. The subset of resource blocks are to be used for sending signals to the base station. The selection of the resource blocks is based on at least one of the measured user equipment related parameter or the measured link related parameter.

According to a third aspect, the object is achieved by a method in a base station for assisting a user equipment in performing link adaptation of signals sent from the user equipment to the base station. The base station and the user equipment are comprised within a wireless communication system. The method comprises sending information to the user equipment. The information comprises an indication of resource blocks available for transmission of signals from the user equipment to the base station. Also, the method comprises receiving resource blocks from the user equipment. The received resource blocks are a user equipment selected subset of the previously sent available resource blocks.

According to a fourth aspect, the object is also achieved by an arrangement in a base station for assisting a user equipment in performing link adaptation of signals sent from the user equipment to the base station. The base station and the user equipment are comprised within a wireless communication system. The arrangement comprises a transmitter. The transmitter is adapted to send information to the user equipment. The information comprises an indication of resource blocks available for transmission of signals from the user equipment to the base station. Further, the arrangement comprises a receiver. The receiver is adapted to receive resource blocks from the user equipment. The received resource blocks are a user equipment selected subset of the previously sent available resource blocks.

By placing the present mechanism for uplink adaptation in the user equipment, an improved uplink adaptation is provided, as the user equipment has more accurate and timely information about power-headroom, buffer status, and the current link conditions, given reciprocity between uplink and downlink signal propagation conditions. The total amount of signalling between the base station and the terminal is thereby reduced, as a more accurate resource allocation may be made, with less padding sent in the uplink. It is thereby possible to increase the load within the system e.g. by letting more terminals participate.

The present methods and arrangements for uplink scheduling, thus lead to higher capacity and coverage of the system. Also better, or more accurate scheduling decisions may be made at the user equipment in stead of at the base station. Further, the overall reduced signalling resulting from the present methods and arrangements, the number of users per cell within the system may be increased. Thereby an improved performance in a communication system is provided.

Other objects, advantages and novel features of the invention will become apparent from the following detailed description of the invention.

### BRIEF DESCRIPTION OF THE DRAWINGS

Embodiments of the present invention will now be described more in detail in relation to the enclosed drawings, in which:

FIG. 1 is a schematic block diagram illustrating a wireless communication system.

FIG. 2a is a block diagram illustrating scheduling communication according to some embodiments.

FIG. 2b is a block diagram illustrating scheduling communication according to some embodiments.

FIG. 2c is a block diagram illustrating possible selection of available resource blocks according to some embodiments.

FIG. 2d is a block diagram illustrating scheduling according to some embodiments.

FIG. 2e is a block diagram illustrating scheduling according to some embodiments.

FIG. 2f is a block diagram illustrating scheduling according to some embodiments.

FIG. 3 is a combined flow chart and event diagram illustrating scheduling communication according to some embodiments.

FIG. 4 is a flow chart illustrating embodiments of method steps in a user equipment.

FIG. 5 is a block diagram illustrating embodiments of an arrangement in a user equipment.

FIG. 6 is a flow chart illustrating embodiments of method steps in a base station.

FIG. 7 is a block diagram illustrating embodiments of an arrangement in a base station.

### DETAILED DESCRIPTION

The invention is defined as a method and an arrangement in a user equipment and as a method and an arrangement in a base station, which may be put into practice in the embodiments described below. This invention may, however, be embodied in many different forms and should not be construed as limited to the embodiments set forth herein; rather, these embodiments are provided so that this disclosure will be thorough and complete, and will fully convey the scope of the invention to those skilled in the art. It should be understood that there is no intent to limit the present methods and/or arrangements to any of the particular forms disclosed, but on the contrary, the present methods and arrangements are to cover all modifications, equivalents, and alternatives falling within the scope of the invention as defined by the claims.

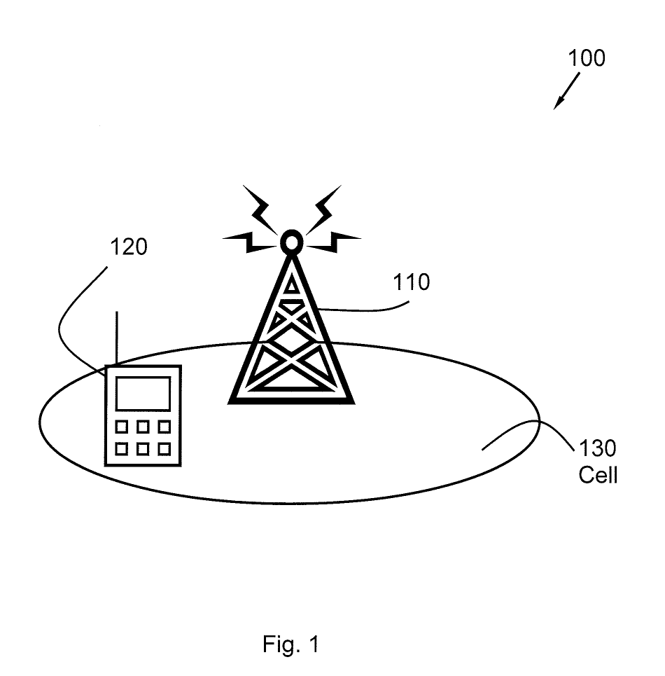

FIG. 1 is a schematic illustration over a wireless communication system 100. The wireless communication system 100 comprises at least one base station 110 and is arranged to comprise at least one user equipment 120. The base station 110 may send and receive wireless signals to and from the user equipment 120 situated within the cell 130.

Although only one base station 110 is shown in FIG. 1, it is to be understood that another configuration of base station transceivers may be connected through, for example, other network nodes, to define the wireless communication system 100. Further, the base station 110 may be referred to as e.g. a Remote Radio Unit, an access point, a Node B, an evolved Node B (eNode B) and/or a base transceiver station, a Radio Base Station (RBS), Access Point Base Station, base station router, etc depending e.g. of the radio access technology and terminology used.

In some embodiments, the user equipment 120 may be represented by a wireless communication device, a wireless communication terminal, a mobile cellular telephone, a Personal Communications Systems terminal, a Personal Digital Assistant (PDA), a laptop, a User Equipment (UE), computer or any other kind of device capable of managing radio resources.

The wireless communication system 100 may be based on technologies such as e.g. Universal Mobile Telecommunication Services (UMTS), Terrestrial Radio Access Network (UTRAN) Long-Term Evolution (LTE), also referred to as e-UTRAN, Global System for Mobile Telecommunications (GSM), Enhanced Data rates for GSM Evolution (EDGE), General Packet Radio Service (GPRS), Code Division Multiple Access (CDMA), Wideband Code Division Multiple Access (WCDMA), CDMA 2000, High Speed Downlink Packet Data Access (HSDPA), High Speed Uplink Packet Data Access (HSUPA), High Data Rate (HDR) High Speed Packet Data Access (HSPA) etc, just to mention some few arbitrary and none limiting examples.

Further, as used herein, the wireless communication system 100 may further, according to some embodiments, refer to Wireless Local Area Networks (WLAN), such as Wireless Fidelity (WiFi) and Worldwide Interoperability for Microwave Access (WiMAX), Bluetooth or according to any other wireless communication technology.

In this description, some exemplary and non-limiting embodiments of the present invention is described, wherein the wireless communication system 100 is based on e-UTRAN and the base station 110 is represented by an eNodeB.

It is to be noted however, that the present solution is not in any way limited to be performed exclusively over a radio interface within the wireless communication network 100, but may be performed within a wireless communication system 100 where some nodes are wirelessly connected and some nodes have a wired connection.

The user equipment 120 may further communicate with other user equipments not shown in FIG. 1, via the base station 110 comprised within the wireless communication system 100.

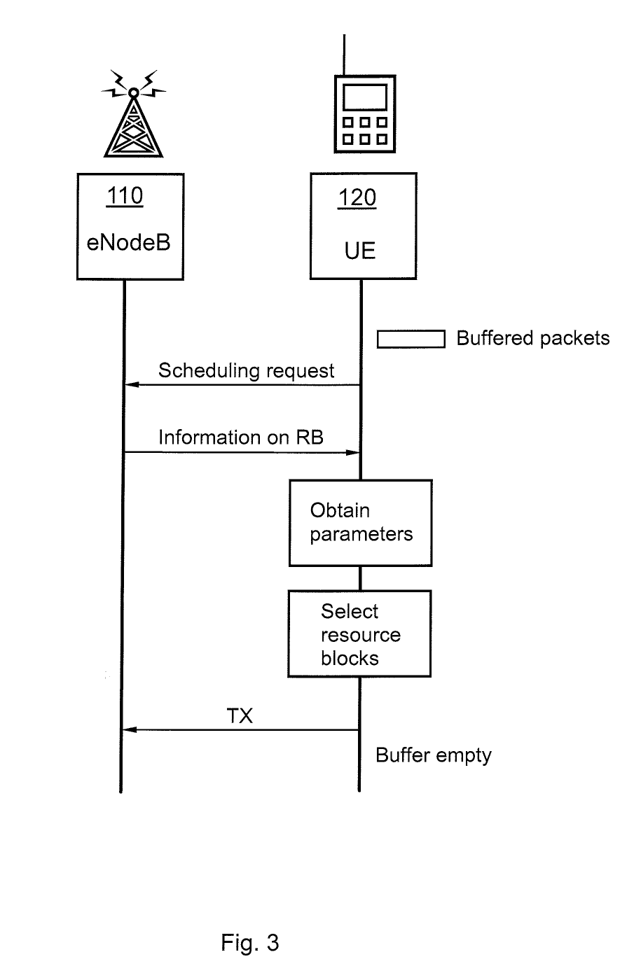

The base station 110 is further adapted to schedule the uplink transmissions from the user equipment 120, to the base station 110. In order to grant a particular user equipment 120 access to a particular uplink resource, a grant is sent from the base station 110 to that particular user equipment 120, based on e.g. a scheduling request sent by the user equipment 120, as will be further explained more in detail in connection with FIG. 3.

The expression “downlink” is here used to specify the transmission from the base station 110 to the user equipment 120, while the expression “uplink” is used to denote the transmission from the user equipment 120 to the base station 110.

However, if the user equipment 120 is allowed to select the most appropriate transport format among a set of transport formats, following current art, it is either required to introduce some means for signalling of the selected transport format as for E-DCH described above, or to introduce “blind decoding” in the base station 110, where the base station 110 must test a number of hypotheses in the decoding process, where each hypothesis corresponds to each of the allowed transport formats that the user equipment 120 may have chosen. But additional uplink signalling is not desirable due e.g. to the aforementioned costs for uplink control signalling, and blind decoding introduces additional complexity in the base station 110.

Thus, embodiments of the present invention introduces a user equipment based transport format selection mechanism, where no new uplink signalling of the selected transport format is required, and blind decoding of multiple transport formats in the base station 110 can be avoided, or the number of blind-decoding hypotheses can be greatly reduced.

The present solution is according to some embodiments based on the idea of sending an implicit signal of the transport format selected by the user equipment 120, such that there are no, or at least less, needs to introduce “blind decoding” in the base station 110, or explicit signalling of the transport format in the uplink. Thus, embodiments of the present invention comprises the user equipment method of how the user equipment 120 may select the transport format such as e.g. modulation and coding of the transmission, and given one selection, which resources the user equipment 120 may use in its transmission.

The aforementioned “implicit signal” of the selected transport format is achieved by establishing rules on how the user equipment 120 should utilize the set of resource blocks made available by the base station 110.

Embodiments of the present invention comprises a method in the user equipment 120, wherein the user equipment 120 receives a set of resource blocks allocated for uplink transmission from the base station 110. The signal of the allocation may be received over a downlink channel. The user equipment 120 then selects a subset of resource blocks for uplink transmission of data. The selection of the subset of resource blocks is based on a user equipment related parameter such as e.g. buffer status value of the buffer of the user equipment 120, power headroom of the user equipment 120.

The present methods and arrangements bring a plurality of advantages. It is e.g. beneficial to avoid scheduling uplink resources such that the received Signal to Interference-plus-Noise Ratio (SINR) in the base station 110 is too low. This could occur e.g. at times when a user equipment is power-limited, and cannot achieve the desired SINR level at the receiver in case the available power resources are spread on a too wide bandwidth. For Wimax, this is one motivation used for a solution called Sub channelization enabling the Wimax base-station to allocate a subset of uplink resources to a user equipment with a limited power budget, according to some embodiments.

Further, the present methods and arrangements bring a better link adaptation in the LTE uplink. Thereby less padding need to be sent within the system 100. Thus also less inter-cell interference on resource blocks that the user equipment 120 does not need, is achieved. In addition, less HARQ transmission due to higher successful reception probability in the receiver, i.e. lower transmission delays may have to be performed.

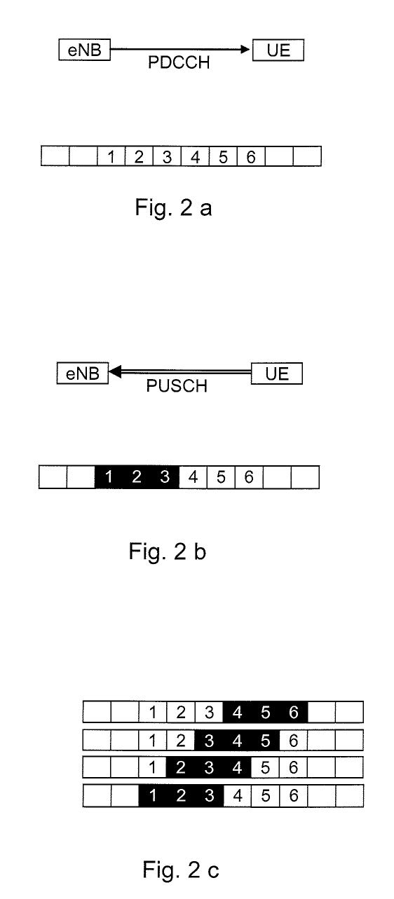

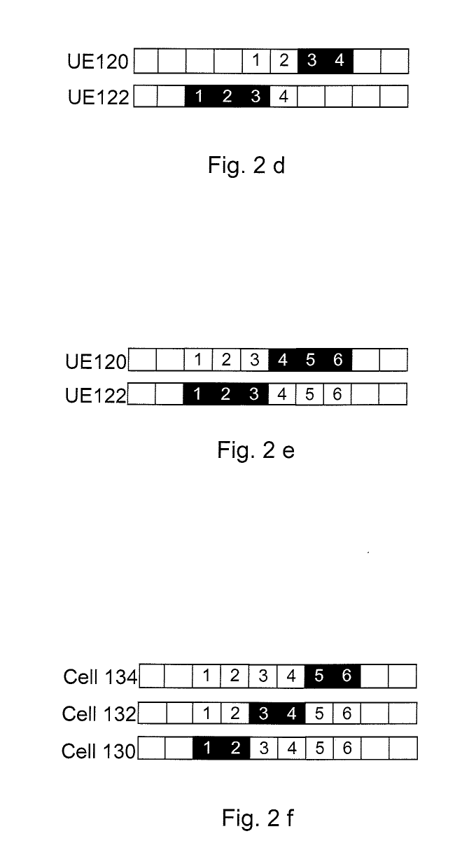

FIG. 2a is a block diagram illustrating scheduling communication according to some embodiments.

The user equipment 120 receives a grant for uplink transmission, where the grant typically may be received on the PDCCH channel, where the grant transmitted by the base station 110. In the illustrated non limiting example, the base station 110 allocates six resource blocks for uplink transmission for user equipments 120 that are receivers of the identity identifying this grant on the PDCCH. The allocated resource blocks are schematically numbered from 1 to 6. The grant may be dedicated, in which only a single user equipment 120 is allowed to utilized the resources, according to some embodiments. Alternatively may the grant be contention based, in which multiple user equipments 120 may be allowed to transmit on the resources.

The base station 110 may send e.g. on the PDCCH a grant indicating that six resource blocks are available for uplink transmission. The grant may be identified by an Radio Network Temporary Identifier (RNTI). A user equipment 120 can be configured to identify this RNTI, such that the user equipment 120 knows that the present grant of six resource blocks is available for transmission. The resource blocks may be dedicated to this user equipment 120, or they may be available to multiple user equipment 120, according to different embodiments. In the latter case, the resource blocks may be subject to contention that may have to be resolved in case collision occurs. The base station 110 may indicate that a specific MCS is assigned in the grant. Alternatively, it may be possible for the user equipment 120 to select among a set of available MCS.

The user equipment 120 may according to some embodiments have only a small uplink buffer that could be emptied e.g. using only three of the available six resource blocks using the assigned MCS. Using current art, the user equipment 120 would still have to construct a large transport block by padding the transport block, and all six resource blocks would have to be used. If the user equipment 120 is power limited, it means that power resources are wasted on bits without information value, i.e. padding. However, such redundant padding transmission may be eliminated or at least somewhat reduced due to the present solution.

Further, it means that it may not be possible to achieve a desired SINR at the base station 110. However, in accordance with some embodiments of the present invention, the user equipment 120 may now choose an appropriate subset of resource blocks. This is to avoid spending terminal transmission power on sending padding bits over resource blocks that may not be needed. The power may thus be concentrated on a narrower bandwidth, possibly resulting in increased SINR over the utilized blocks.

FIG. 2b is a block diagram illustrating scheduling communication according to some embodiments.

Based on its buffer status and/or power headroom status, the user equipment 120 may decide to use a subset of the resources available in the grant. In the illustrated example, the user equipment 120 minimizes, or at least reduces padding by utilizing only three resource blocks. Different rules of which resource blocks to utilize may apply. In the illustrated exemplary embodiment, the user equipment 120 allocates resources “from left to right”. The presence of energy on the first three resource blocks and the absence of energy of the remaining resource blocks may serve as an implicit signal for indicating the Transport Format selected by the user equipment 120, according to some embodiments.

It may be assumed for simplicity that the rule for selecting the resource blocks in the user equipment 120 may be from “left to right”, as illustrated. However, some embodiments of the present invention does not out-rule different mechanisms for selecting resource blocks, such that the selection mechanism indicates what MCS the user equipment 120 has selected. Additional aspects of the user equipment 120 selection may also be indicated using the resource block selection mechanism.

FIG. 2c is a block diagram illustrating an example of multiple ways of selecting three consecutive resource blocks out of six blocks made available for uplink transmission, according to some embodiments. In the depicted example, assuming Single Carrier FDMA, i.e. consecutive blocks, there are thus four different ways of selecting three resource blocks, where each selection may be used as an implicit indication of the Transport Format selected by the user equipment 120. For example, the four selections above could e.g. be different in terms of Modulation and/or Coding. Alternatively, the four different transmission patterns could indicate some other parameter that differentiates the state in the user equipment 120. The base station 110 would then detect the presence or non-presence of energy on the respective received resource blocks, and thereby deduce which MCS the user equipment 120 has selected. Alternatively, the base station 110 may, depending on the resource block choice made by the user equipment 120, receive information about some other parameter in the user equipment 120.

In the base station 110, it may be detected that a transmission has occurred on the three “leftmost” resource blocks, but no energy is detected on the remaining resource blocks. Thus, the base station 110 may conclude, without any blind detection of multiple transport formats that the user equipment 120 has selected and used a specific transport format. Thus, the receiver mechanism may be simplified.

In another embodiment, the user equipment 120 may have a large buffer, but the user equipment 120 has limited power resources e.g. due to a long distance to the base station 110. In such a case, it may be more efficient to avoid spreading the user equipment 120 power over a large band, i.e. many resource blocks, since the energy per bit may be too low for successful reception in the base station 110, i.e. the SINR may be at an undesired low level. In such a case, the user equipment 120 may concentrate its transmission power on e.g. three resource blocks, where the transmission of information bits may be reduced, while the probability of successful decoding in the base station 110 may be improved. In such a case it may be beneficial to allow the user equipment 120 to select among multiple MCS:es. In FIG. 2c, four different ways of utilizing three consecutive resource blocks are illustrated, where each of the selections could be associated with a different MCS.

A specific embodiment comprises the case when the user equipment 120 has no data at all in its buffers, then the user equipment 120 may omit utilizing any resources granted on PDCCH, according to some embodiments.

FIG. 2d is a block diagram illustrating scheduling according to some embodiments.

The grants sent by the base station 110 to different user equipment 120, 122 may also use overlapping resource blocks, according to some embodiments. In this way, the base station 110 may opportunistically use statistical multiplexing, if it expects the user equipment 120, 122 to not use the full resource block allocation. Assigning different phase rotations of the reference symbols may simplify the base station 110 decoding process, as it could then identify which resource blocks that where used by each user equipment 120, 122 and thus also the transport format. There may however be a limitation to this, as there may only be 12 phase rotations available per cell 130, 132, 134. Therefore it may not be possible to assign user equipment unique rotations. Instead, user equipment 120, 122 may be able to randomly select the phase rotation, according to some embodiments. Thus, in some cases, the user equipment 120, 122 may select the same rotation when transmitting in the same resource blocks. In any case, utilizing the phase rotation as a means for distinguishing the transmissions of multiple user equipment 120, 122 may improve the decoding success-rate in the base station 110.

As yet another improvement to the embodiment above, it could be defined that a user equipment 120 measuring that a neighbouring cell pilot signal is stronger than a predefined threshold, or that the relative pilot strength of a neighbouring cell pilot, relative to the serving pilot exceeds a threshold, is utilizing a subset of available resource blocks according to the present solution, where the subset to be utilized by the user equipment 120 is provided by higher-layer signalling, and the user equipment selection is signalled by the mechanism provided by the present method.

A further embodiment comprises the solution where a user equipment 120 is allocated a limited set of transport formats, where the limited set is a subset of all transport formats, and the user equipment 120 may be allowed to freely select any of the transport formats in the limited set, such that the selection is based on at least one parameter out of buffer fill level status and/or power headroom, according to some embodiments. The subset may be controlled either by RRC signalling or signalling on PDCCH.

This mechanism may reduce the effort in the base station 110, as the blind-decoding hypotheses may be reduced.

FIG. 2e is a block diagram illustrating scheduling according to some embodiments.

If the grant is sent to multiple user equipment 120, 122, then proper decoding can be simplified by letting the user equipment 120, 122 use different phase rotations of the reference symbols. For example, if user equipment 120 decides to transmit in resource blocks 4-6 and user equipment 122 in resource blocks 1-3, then the base station 110 can by reading the reference symbols in each resource block determine that two different user equipment 120, 122 are performing the transmission, instead of one user equipment 120 transmitting over all resource blocks 1-6. The same restrictions when it comes to the number of phase rotations apply here as explained in FIG. 2d.

FIG. 2f is a block diagram illustrating an exemplary embodiment of three cells 130, 132, 134 where user equipment 120 in each of the cells 130, 132, 134 are configured to primarily start its selection of resource blocks for transmission according to a predefined pattern. Since user equipment 120 at the cell edge are likely to utilize less resource blocks, due to a worse power budget, it comes naturally that user equipment 120 that are likely to interfere transmissions in other cells 130, 132, 134 may transmit in resource blocks that are less relevant for neighbouring cells 130, 132, 134. A user equipment 120 close to the base station 110 may utilize all resource blocks, if needed, according to some embodiments.

As yet another embodiment of the present invention is the solution for defining the user equipment patterns for resource block selection to mitigate inter-cell interference in the best possible way. Assuming still that six resource blocks are allocated in a grant, it may be defined that user equipment 120, 122 in neighbouring cells 130 and 132 are performing resource block selection in different ways. For example, it could be defined that user equipment 120 in Cell 130 start the resource block allocation from resource block 4, user equipment 122 in Cell 132 start the resource block allocation from resource block 1, and user equipment 124 in Cell 134 start the resource block allocation from resource block 3. In this way, it may be possible that the primary selections of resource blocks by user equipment 120, 122, 124 in neighbouring cells 130, 132, 134 are non-interfering, as illustrated in FIG. 2f.

FIG. 3 is a combined flow chart and event diagram illustrating scheduling communication according to some embodiments.

When the user equipment 120 has data to transmit in the buffer, the user equipment 120 may send a scheduling request to the base station 110, which scheduling request comprises an indication that the user equipment 120 requests resources for data transmission.

The base station 110 may reply by sending a grant to the user equipment 120 over a downlink channel. The channel over which the grant is sent may be e.g. a PDCCH channel in LTE, where the grant assignment is characterized by at least an indication of which uplink resource blocks are available.

According to some embodiments, the signalling may be conveyed using existing Downlink Control Information (DCI) formats, resulting in minor updates to the existing specifications. Alternatively, some new DCI may be specified for resources or user equipment 120 supporting the mechanism illustrated here.

The grant may also according to some embodiments comprise an indication of one or multiple allowed modulation and coding schemes.

The grant sent by the base station 110 may be a grant that is sent to a single user equipment 120, as a “dedicated resource”, or a grant that is available for multiple user equipment 120 as a “contention based resource”.

The user equipment 120 may select a subset of resource blocks from the resource blocks made available in the grant for its uplink transmission. The selection is based on at least one of parameters indicating the buffer fill level status of the user equipment 120 and the power headroom of the user equipment 120.

Rules and/or constraints for how the user equipment 120 may select the subset of resource blocks may be pre-defined or configured by higher layers, such that the presence or non-presence of a transmission on one or several resource blocks operates as an implicit indication of the transport block selected by the user equipment 120. Alternatively, the selection constraints may be transmitted on PDCCH.

By letting the user equipment 120 randomly select the phase rotation of the reference symbols, the base station 110 can easier detect the transmissions from different user equipment 120 in cases where several user equipment 120 are allowed to transmit in the same resource blocks.

Uplink reference signals may be used for coherent demodulation of different uplink physical channels. Uplink reference signals are time-multiplexed and transmitted in the fourth symbol of each uplink slot. The bandwidth is the same as the ongoing uplink transmission, i.e. it spans the same number of resource blocks. The reference signal sequences are ordered into groups, so that each group contains one sequence for each possible resource allocation. There are 30 different groups, and there is one group per cell 130. Thus, for a given bandwidth of a resource allocation, the same reference signal may be used. Phase rotations can be used to differentiate between transmissions in the same resource block. This can be used to separate transmissions of several different user equipments 120 transmitting in the same resource block. This may be used e.g. for PUCCH transmission. In total, twelve phase rotations are available, but not all can be used if orthogonality is to be maintained. For PUCCH, typically six rotations may be used, according to some embodiments.

A specific embodiment of the present solution is the one where the user equipment 120 selects between the two options of sending on available resource blocks, and not sending on any of the resource blocks made available for transmission, where the decision of not sending any transmission is based on the buffer fill-level. In particular, if the buffers are empty, the user equipment 120 may select to not send any uplink transmission.

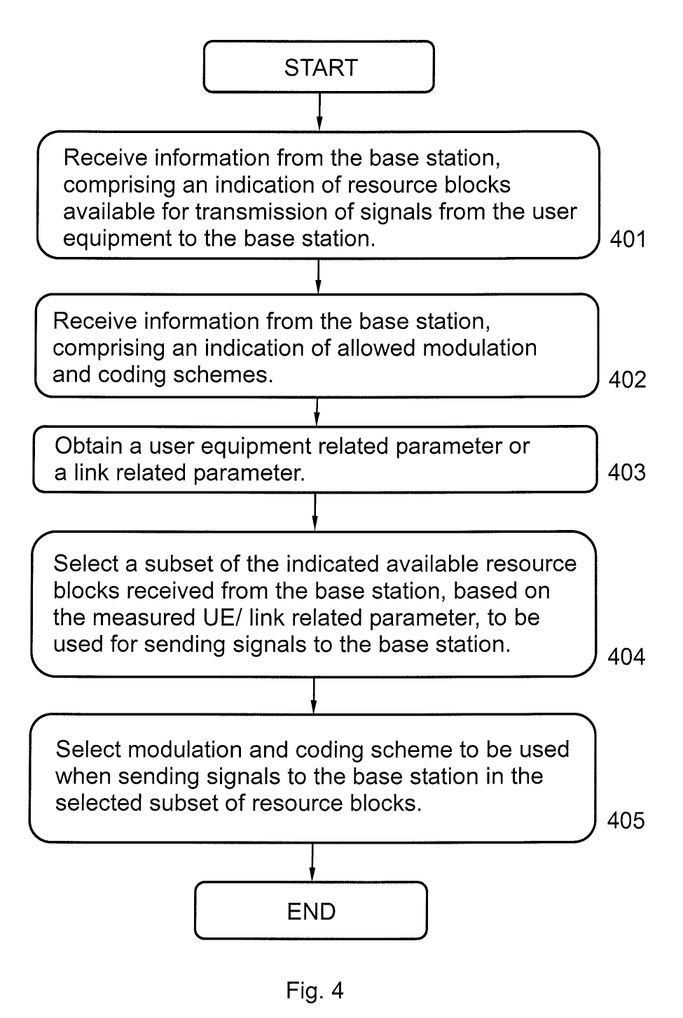

FIG. 4 is a flow chart illustrating embodiments of method steps 401-405 in a user equipment 120. The method aims at performing link adaptation of signals sent from the user equipment 120 to a base station 110. The base station 110 and the user equipment 120 are comprised within a wireless communication system 100.

To appropriately perform link adaptation of signals sent from the user equipment 120 to a base station 110, the method may comprise a number of method steps 401-405.

It is however to be noted that some of the described method steps 401-405 are optional and only comprised within some embodiments. Further, it is to be noted that the method steps 401-405 may be performed in any arbitrary chronological order and that some of them, e.g. step 401 and step 402, or even all steps may be performed simultaneously or in an altered, arbitrarily rearranged, decomposed or even completely reversed chronological order. The method may comprise the following steps:

Step 401

Information is received from the base station 110, comprising an indication of resource blocks available for transmission of signals from the user equipment 120 to the base station 110.

Step 402

Information is received from the base station 110, comprising an indication of allowed modulation and coding schemes. This step is optional.

Step 403

At least one of a user equipment related parameter or a link related parameter is obtained.

The user equipment related parameter may be any of: buffer status value of the buffer of the user equipment 120, or power headroom of the user equipment 120.

The link related parameter is any of measured downlink path loss, measured downlink reference symbol strength, measured downlink pilot signal strength or measured received signal to noise ratio (SINR).

Step 404

A subset of the indicated available resource blocks received from the base station 110 is selected, based on the measured user equipment related parameter or the measured link related parameter, to be used for sending signals to the base station 110.

The step of selecting a subset of the indicated available resource blocks received from the base station 110, may comprise mapping the measured user equipment related parameter or the measured link related parameter against a table, which table comprises resource block selection related information, according to some embodiments.

According to some embodiments, the step of selecting a subset of the indicated available resource blocks received from the base station 110 comprises selecting the subset of resource blocks such that the pattern of selected resource blocks serves as an indication of uplink control information. The uplink control information may be any of: transport format, indication of further resource needs i.e. happy bit, or power headroom.

Further, according to some embodiments the step of selecting a subset of the indicated available resource blocks received from the base station 110 comprises selecting zero resource blocks in case the buffer of the user equipment 120 is empty.

Step 405

Modulation and coding scheme are selected, to be used when sending signals to the base station 110 in the selected subset of resource blocks. This step is optional.

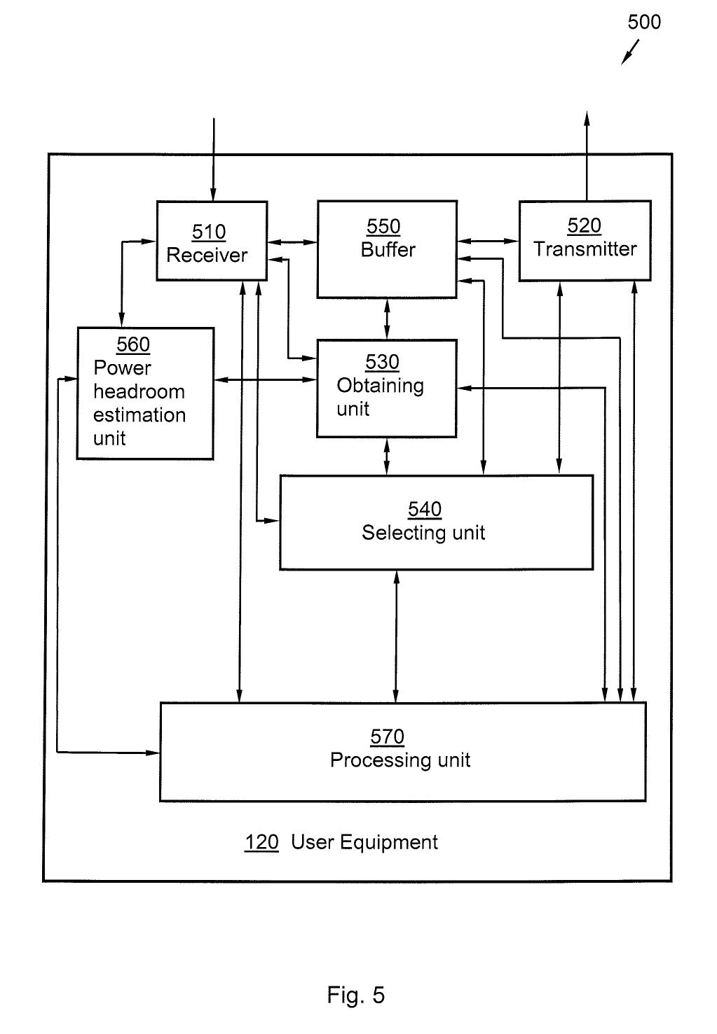

FIG. 5 is a block diagram illustrating embodiments of an arrangement 500 in a user equipment 120. The arrangement 500 is configured to perform the method steps 401-405 for performing link adaptation of signals sent from the user equipment 120 to a base station 110. The base station 110 and the user equipment 120 are comprised within a wireless communication system 100.

For the sake of clarity, any internal electronics of the arrangement 500, not relevant for understanding the present method has been omitted from FIG. 5.

The arrangement 500 in the user equipment 120 comprises a receiver 510. The receiver 510 is adapted to receive information from the base station 110, comprising an indication of resource blocks available for transmission of signals from the user equipment 120 to the base station 110.

Further, the arrangement 500 comprises an obtaining unit 530. The obtaining unit 530 is adapted to obtain at least one of a user equipment related parameter and/or a link related parameter. According to some embodiments, the obtained at least one parameter may be measured.

Also, the arrangement 500 comprises a selecting unit 540. The selecting unit 540 is adapted to select a subset of the indicated available resource blocks received from the base station 110, based on at least one of the measured user equipment related parameter or the measured link related parameter, to be used for sending signals to the base station 110.

According to some embodiments, the arrangement 500 comprises a buffer 550. The optional buffer 550 is arranged to buffer data to be sent to the base station 110.

In addition, the arrangement 500 may optionally comprise a power headroom estimation unit 560. The power headroom estimation unit 560 may be arranged to estimate the power headroom, upon request e.g. from the obtaining unit 530.

Further, the arrangement 500 may, according to some embodiments, further comprise a processing unit 570. The processing unit 570 may be represented by e.g. a Central Processing Unit (CPU), a processor, a microprocessor, or other processing logic that may interpret and execute instructions. The processing unit 570 may perform all data processing functions for inputting, outputting, and processing of data including data buffering and device control functions, such as call processing control, user interface control, or the like.

In addition, the arrangement 500 may comprise, according to some embodiments, a transmitter 520. The transmitter 520 may be arranged to send radio signals.

It is to be noted that the described units 510-570 comprised within the arrangement 500 in a user equipment 120 may be regarded as separate logical entities, but not with necessity as separate physical entities. Any, some or all of the units 510-570 may be comprised or co-arranged within the same physical unit. However, in order to facilitate the understanding of the functionality of the arrangement 500, the comprised units 510-570 are illustrated as separate units in FIG. 5.

Thus the receiving unit 510 and e.g. the transmitter unit 520 may, according to some embodiments, be comprised within one physical unit, a transceiver, which may comprise a transmitter circuit and a receiver circuit, which respectively transmits outgoing radio frequency signals to the base station 110 and receives incoming radio frequency signals from the base station 110 via an optional antenna.

Computer Program Product in the User Equipment 120

The method steps 401-405 in the user equipment 120 may be implemented through one or more processor units 570 in the user equipment 120, together with computer program code for performing the functions of the present method steps 401-405. Thus a computer program product, comprising instructions for performing the method steps 401-405 in the user equipment 120 may perform link adaptation of signals sent from the user equipment 120 to a base station 110. The base station 110 and the user equipment 120 are comprised within a wireless communication system 100.

The computer program product mentioned above may be provided for instance in the form of a data carrier carrying computer program code for performing the method steps according to the present solution when being loaded into the processor unit 570. The data carrier may be e.g. a hard disk, a CD ROM disc, a memory stick, an optical storage device, a magnetic storage device or any other appropriate medium such as a disk or tape that can hold machine readable data. The computer program code can furthermore be provided as pure program code on a server and downloaded to the user equipment 120 remotely, e.g. over an Internet or an intranet connection.

Further, a computer program product comprising instructions for performing at least some of the method steps 401-405 may be used for implementing the previously described method in the user equipment 120 for performing link adaptation of signals sent from the user equipment 120 to a base station 110, when the computer program product is run on a processing unit 570 comprised within the user equipment 120.

The present invention may be embodied as a method and an arrangement in a user equipment 120, and/or computer program products. Accordingly, embodiments of the present invention may take the form of an entirely hardware embodiment, a software embodiment or an embodiment combining software and hardware aspects all generally referred to herein as a “circuit”. Furthermore, embodiments of the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices etc.

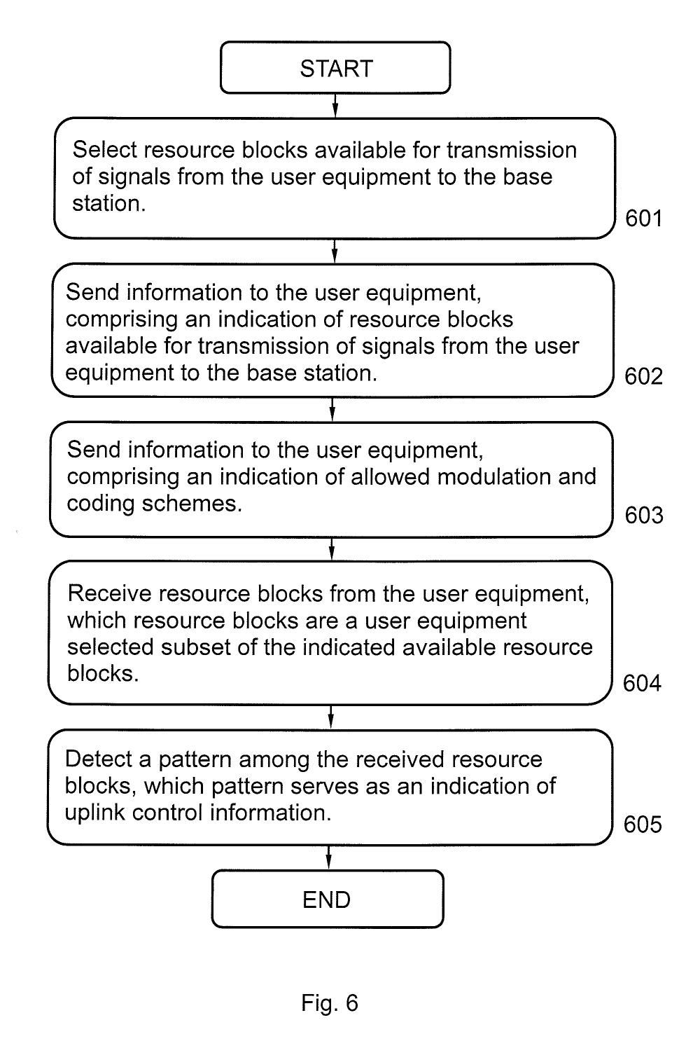

FIG. 6 is a flow chart illustrating embodiments of method steps in a base station 110. The method aims at assisting a user equipment 120 in performing link adaptation of signals sent from the user equipment 120 to the base station 110. The base station 110 and the user equipment 120 are comprised within a wireless communication system 100.

To appropriately assist the user equipment 120 in performing link adaptation of signals sent from the user equipment 120 to the base station 110, the method may comprise a number of method steps 601-605, to be performed in the base station 110.

It is however to be noted that some of the described method steps 601-605 are optional and only comprised within some embodiments. Further, it is to be noted that the method steps 601-605 may be performed in any arbitrary chronological order and that some of them, e.g. step 602 and step 603, or even all steps may be performed simultaneously or in an altered, arbitrarily rearranged, decomposed or even completely reversed chronological order. The method may comprise the following steps:

Step 601

Resource blocks available for transmission of signals from the user equipment 120 to the base station 110 are selected. This step is optional.

Step 602

Information is sent to the user equipment 120. The information comprises an indication of resource blocks available for transmission of signals from the user equipment 120 to the base station 110.

Step 603

Information is sent to the user equipment 120. The information comprises an indication of allowed modulation and coding schemes, according to some embodiments. This step is optional.

Step 604

Resource blocks are received from the user equipment 120, which resource blocks are a user equipment selected subset of the indicated available resource blocks.

Step 605

A pattern is detected among the received resource blocks. The pattern serves as an indication of uplink control information, transmitted from the user equipment 120 to the base station 110. The uplink control information may be any of transport format, indication of further resource needs or power headroom, according to some embodiments. This step is optional.

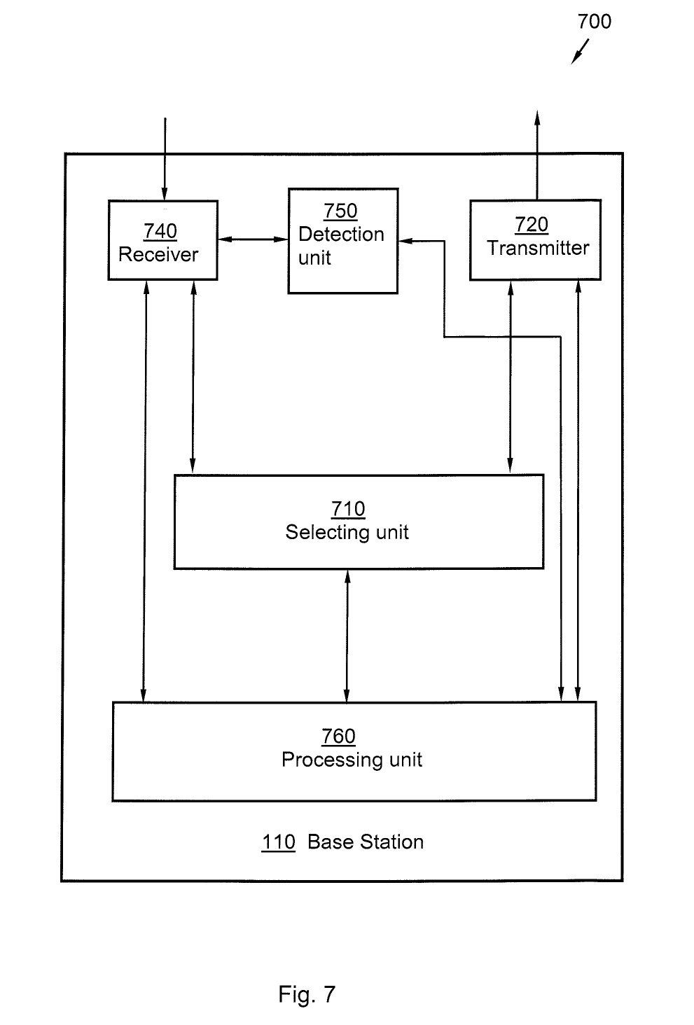

FIG. 7 is a block diagram illustrating embodiments of an arrangement 700 in a base station 110. The arrangement 700 is configured to perform the method steps 601-605 for assisting a user equipment 120 in performing link adaptation of signals sent from the user equipment 120 to the base station 110. The base station 110 and the user equipment 120 are comprised within a wireless communication system 100.

For the sake of clarity, any internal electronics of the arrangement 700, not completely necessary for understanding the present method has been omitted from FIG. 7.

The arrangement 700 comprises a transmitter 720. The transmitter 720 is adapted to send information to the user equipment 120, comprising an indication of resource blocks available for transmission of signals from the user equipment 120 to the base station 110.

Also, the arrangement 700 comprises a receiver 740. The receiver 740 is adapted to receive resource blocks from the user equipment 120, which resource blocks are a user equipment selected subset of the indicated available resource blocks.

Further yet, the arrangement 700 may, according to some embodiments comprise a selecting unit 710. The selecting unit 710 may be adapted to select resource blocks available for transmission of signals from the user equipment 120 to the base station 110.

Still further, the arrangement 700 according to some embodiments may comprise a detecting unit 750. The detecting unit 750 may be adapted to detect a pattern among the received resource blocks, which pattern serves as an indication of uplink control information. The uplink control information may be any of e.g. transport format, indication of further resource needs or power headroom.

Further, the arrangement 700 may, according to some embodiments, further comprise a processing unit 760. The processing unit 760 may be represented by e.g. a Central Processing Unit (CPU), a processor, a microprocessor, or other processing logic that may interpret and execute instructions. The processing unit 760 may perform data processing functions for inputting, outputting, and processing of data including data buffering and device control functions, such as call processing control, user interface control, or the like.

It is to be noted that the described units 710-760 comprised within the arrangement 700 in a base station 110 may be regarded as separate logical entities, but not with necessity as separate physical entities. Any, some or all of the units 710-760 may be comprised or co-arranged within the same physical unit. However, in order to facilitate the understanding of the functionality of the arrangement 700, the comprised units 710-760 are illustrated as separate units in FIG. 7.

Thus the receiving unit 740 and e.g. the transmitter 720 may, according to some embodiments, be comprised within one physical unit, a transceiver, which may comprise a transmitter circuit and a receiver circuit, which respectively transmits outgoing radio frequency signals to the user equipment 120 and receives incoming radio frequency signals from the user equipment 120 via an optional antenna.

Computer Program Product in the Base Station 110

The method steps 601-605 in the base station 110 may be implemented through one or more processor units 760 in the base station 110, together with computer program code for performing the functions of the present method steps 601-605. Thus a computer program product, comprising instructions for performing the method steps 601-605 in the base station 110 may assist a user equipment 120 in performing link adaptation of signals sent from the user equipment 120 to a base station 110. The base station 110 and the user equipment 120 are comprised within a wireless communication system 100.

The computer program product mentioned above may be provided for instance in the form of a data carrier carrying computer program code for performing the method steps according to the present solution when being loaded into the processor unit 760. The data carrier may be e.g. a hard disk, a CD ROM disc, a memory stick, an optical storage device, a magnetic storage device or any other appropriate medium such as a disk or tape that can hold machine readable data. The computer program code can furthermore be provided as pure program code on a server and downloaded to the base station 110 remotely, e.g. over an Internet or an intranet connection.

Further, a computer program product comprising instructions for performing at least some of the method steps 601-605 may be used for implementing the previously described method in the base station 110 may assist a user equipment 120 in performing link adaptation of signals sent from the user equipment 120 to a base station 110, when the computer program product is run on a processing unit 760 comprised within the base station 110.

The present invention may be embodied as a method and an arrangement in a base station 110, and/or computer program products. Accordingly, embodiments of the present invention may take the form of an entirely hardware embodiment, a software embodiment or an embodiment combining software and hardware aspects all generally referred to herein as a “circuit”. Furthermore, embodiments of the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices etc.

Further by means of example and in order to simplify the comprehension, the term SINR has been consistently used in this text when describing a Signal to Interference and Noise Ratio (SINR), which is the ratio between the level of a desired signal to the level of background noise and signal disturbance. The higher the ratio, the less obtrusive is the background noise. However, there exist other acronyms which are sometimes used to describe the same or a similar ratio, like e.g. the Signal to Noise Ratio (SNR or S/N), Signal to Noise and Interference Ratio (SNIR), Signal to noise and Interference Ratio (SIR) or an inversion of the ratio, like Interference to Signal Ratio, (ISR). Any of these or similar ratios may be used in the context of this description instead of the SINR.

The terminology used in the detailed description of the particular exemplary embodiments illustrated in the accompanying drawings is not intended to be limiting of the invention.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

1-17. (canceled)

18. A method in a user equipment for link adaptation of signals sent from the user equipment to a base station, the base station and the user equipment being comprised within a wireless communication system, the method comprising:
receiving information from the base station comprising an indication of resource blocks available for transmission of signals from the user equipment to the base station;
obtaining at least one of a user equipment related parameter and a link related parameter; and
selecting a subset of the indicated available resource blocks received from the base station based on at least one of the measured user equipment related parameter and the measured link related parameter, said selected subset of the indicated available resource blocks to be used for sending signals to the base station.

19. The method according to claim 18, wherein the user equipment related parameter comprises any of a buffer status value of the buffer of the user equipment and a power headroom of the user equipment.

20. The method according to claim 18, wherein the link related parameter comprises any of a measured downlink path loss, a measured downlink reference symbol strength, a measured downlink pilot signal strength, and a measured received signal to noise ratio.

21. The method according to claim 18, wherein selecting a subset of the indicated available resource blocks received from the base station comprises mapping at least one of the measured user equipment related parameter and the measured link related parameter against a table, said table comprising resource block selection related information.

22. The method according to claim 18, further comprising:
receiving information from the base station comprising an indication of allowed modulation and coding schemes; and
selecting a modulation and coding scheme to be used when sending signals to the base station in the selected subset of resource blocks.

23. The method according to claim 18, wherein selecting a subset of the indicated available resource blocks received from the base station comprises selecting the subset of resource blocks such that the pattern of selected resource blocks serves as an indication of uplink control information.

24. The method according to claim 23, wherein the uplink control information comprises any of a transport format, an indication of further resource needs, and a power headroom.

25. The method according to claim 18, wherein selecting a subset of the indicated available resource blocks received from the base station comprises selecting zero resource blocks when a buffer of the user equipment is empty.

26. The method according to claim 18, wherein the wireless communication system is based on the Universal Mobile Telecommunication Services Terrestrial Radio Access Network Long-Term Evolution and the base station comprises an eNodeB.

27. An arrangement in a user equipment for link adaptation of signals sent from the user equipment to a base station, the base station and the user equipment being comprised within a wireless communication system, the arrangement comprising:
a receiver configured to receive information from the base station comprising an indication of resource blocks available for transmission of signals from the user equipment to the base station;
an obtaining unit configured to obtain at least one of a user equipment related parameter and a link related parameter; and
a selecting unit configured to select a subset of the indicated available resource blocks received from the base station based on at least one of the measured user equipment related parameter and the measured link related parameter, said selected subset of the indicated available resource blocks to be used for sending signals to the base station.

28. A method in a base station for assisting a user equipment in performing link adaptation of signals sent from the user equipment to the base station, the base station and the user equipment being comprised within a wireless communication system, the method comprising:
sending information to the user equipment comprising an indication of resource blocks available for transmission of signals from the user equipment to the base station; and
receiving resource blocks from the user equipment comprising a user equipment selected subset of the indicated available resource blocks.

29. The method according to claim 28, further comprising:
selecting the resource blocks available for transmission of signals from the user equipment to the base station.

30. The method according to claim 28, further comprising:
sending information to the user equipment comprising an indication of allowed modulation and coding schemes.

31. The method according to claim 28, further comprising:
detecting a pattern among the received resource blocks, wherein said pattern serves as an indication of uplink control information.

32. The method according to claim 31, wherein the uplink control information comprises any of a transport format, an indication of further resource needs, and power headroom.

33. The method according to claim 28, wherein the wireless communication system is based on the Universal Mobile Telecommunication Services Terrestrial Radio Access Network Long-Term Evolution and the base station comprises an eNodeB.

34. An arrangement in a base station for assisting a user equipment in performing link adaptation of signals sent from the user equipment to the base station, the base station and the user equipment being comprised within a wireless communication system, the arrangement comprising:
a transmitter configured to send information to the user equipment, comprising an indication of resource blocks available for transmission of signals from the user equipment to the base station; and
a receiver configured to receive resource blocks from the user equipment comprising a user equipment selected subset of the indicated available resource blocks.
